(19) United States
(12) Patent Application Publication
(10) Pub. No.: US 2006/0033665 A1
(43) Pub. Date: Feb. 16, 2006

(54) Arrangment for giving planar antenna added strength in construction

(75) Inventor: Pei-Lin Yang, Hsinchu (TW)

Correspondence Address: BACON & THOMAS, PLLC, 625 SLATERS LANE, FOURTH FLOOR, ALEXANDRIA, VA, 22314, US

(73) Assignee: EMTAC TECHNOLOGY CORP., Hsinchu (TW)

(21) Appl. No.: 11/119,896

(22) Filed: May 3, 2005

(30) Foreign Application Priority Data
Aug. 13, 2004 (TW) 093212918

(51) Int. Cl. H01Q 1/38; H01Q 1/48

(52) U.S. Cl. 343/700 MS; 343/846

(57) ABSTRACT

The present invention is to provide an arrangement for giving a planar antenna added strength in construction, which comprises a grounded metal element on bottom of a dielectric substrate of the planar antenna and a curved radiating metal member above the dielectric substrate including two integral radial supports bent and extended downward, wherein one support has one end electrically connected to circuitry in the dielectric substrate for serving as a feed point, and the other support has one end passed the dielectric substrate to connect to the grounded metal element for serving as a ground terminal, so as to prevent the planar antenna from being easily deformed.

### FIELD OF THE INVENTION

The present invention relates to planar antennas, more particularly to an arrangement for giving a planar antenna added strength in construction by integrally forming two supports on a radiating metal member of the planar antenna as feed point and ground terminal respectively, so as to add strength to the construction of the planar antenna and prevent it from being easily deformed.

### BACKGROUND OF THE INVENTION

A conventional planar antenna mounted in a GSM (Global System for Mobile Communications) based or PDC (personal digital cellular) based cellular phone is shown in FIG. 1. The planar antenna comprises a disk-shaped dielectric substrate 10 formed of resin, a grounded metal element 11 on bottom of the dielectric substrate 10, the grounded metal element 11 being formed by photolithography and etching, and a curved radiating metal member 12 above the dielectric substrate 10, the radiating metal member 12 having two radial feed posts 131 and 132 in its intermediate portion, the feed posts 131 and 132 being extended downward wherein the feed post 131 proximate an outer edge of the radiating metal member 12 has a bottom end electrically connected to circuitry in the dielectric substrate 10 for serving as a feed point and the feed post 132 proximate an inner edge of the radiating metal member 12 has a bottom end passed the dielectric substrate 10 to connect to the grounded metal element 11 for serving as a ground terminal. This completes the manufacturing of planar antenna wherein signal can be transmitted or received through the feed point.

In the well-known planar antenna, the radiating metal member 12 is supported above the dielectric substrate 10 by two feed posts 131 and 132 with a distance formed therebetween. The feed posts 131 and 132 are formed in the planar antenna by soldering and which may inevitably increase both the manufacturing time and manufacturing cost. One ends of the feed posts 131 and 132 are fixedly connected to the dielectric substrate 10 and the other ends of the feed posts 131 and 132 are fixedly connected to top and bottom faces of the radiating metal member 12 respectively. Moreover, the planar antenna is adapted to transmit or receive signal through air (i.e., air as medium) and a predetermined distance must be maintained between the radiating metal member 12 and the dielectric substrate 10 so as to ensure design characteristics. However, support strength of the feed posts 131 and 132 is limited. The feed posts 131 and 132 are thus subject to deformation due to collision or vibration in the process of manufacturing the planar antenna, mounting the planar antenna in a cellular phone, or after the planar antenna has been mounted in the cellular phone. As a result, the predetermined distance between the radiating metal member 12 and the dielectric substrate 10 cannot be maintained.

For solving the above problem, some planar antenna manufacturers and designers mount one or more styrofoam members (two are shown) 141 and 142 between the radiating metal member 12 and the dielectric substrate 10. The styrofoam members 141 and 142 are adapted to lessen the effect or absorb the force of shocks and jarring in response to colliding or vibrating the planar antenna. As an end, the undesired deformation of the feed posts 131 and 132 can be substantially eliminated and thus ensure design characteristics of the planar antenna. In practice, however, a large percentage of the force of shocks and jarring exerted on the planar antenna in the cellular phone cannot be absorbed by the styrofoam members 141 and 142 when such occurs. As a result, the feed posts 131 and 132 are still subject to deformation, the predetermined distance between the radiating metal member 12 and the dielectric substrate 10 cannot be maintained, design characteristics of the planar antenna deteriorate, and a normal signal transmission or receiving is compromised. Thus, a need for improvement exists in order to overcome the inadequacy of the prior art.

### SUMMARY OF THE INVENTION

After considerable research and experimentation, an arrangement for giving a planar antenna added strength in construction according to the present invention has been devised so as to overcome the above drawbacks (e.g., unreliable radiating metal member due to weak support and being difficult of maintaining design characteristics) of the prior art. The planar antenna comprises a dielectric substrate; a grounded metal element on bottom of the dielectric substrate; and a curved radiating metal member above the dielectric substrate, the radiating metal member including two integral radial supports bent and extended downward; wherein one support has one end electrically connected to circuitry in the dielectric substrate for serving as a feed point, and the other support has one end passed the dielectric substrate to connect to the grounded metal element for serving as a ground terminal.

It is an object of the present invention to integrally form two supports with the radiating metal member and bend, extend downward same therefrom. The supports are served as feed point and ground terminal respectively. By utilizing this arrangement added strength in construction is given to the planar antenna so as to prevent it from deforming easily. Moreover, the predetermined distance between the radiating metal member and the dielectric substrate can be maintained and design characteristics of the planar antenna are ensured.

The above and other objects, features and advantages of the present invention will become apparent from the following detailed description taken with the accompanying drawings.

### BRIEF DESCRIPTION OF THE DRAWINGS

FIG. 1 is a perspective view of a conventional planar antenna;

FIG. 2 is a perspective view of a first preferred embodiment of planar antenna according to the invention;

FIG. 3 is a sectional view of the planar antenna shown in FIG. 2; and

FIG. 4 is a perspective view of a second preferred embodiment of planar antenna according to the invention.

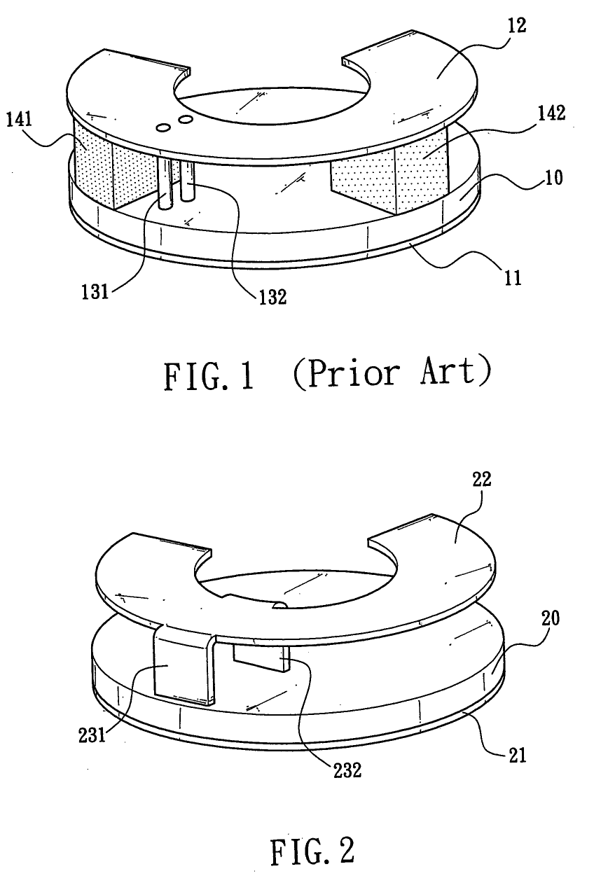

### DETAILED DESCRIPTION OF THE PREFERRED EMBODIMENTS

Referring to FIG. 2, there is shown a first preferred embodiment of planar antenna according to the invention. The planar antenna is adapted to operate in many different bands and the planar antenna is preferably implemented as a PIFA (planar inverted-F antenna) for a GSM or PDC based cellular phone as detailed below.

Referring to FIG. 2, the PIFA is adapted to operate in dual-band by configuring as a single feed double path antenna. The PIFA comprises a disk-shaped dielectric substrate 20 formed of resin, a grounded metal element 21 on bottom of the dielectric substrate 20, the grounded metal element 21 being formed by photolithography and etching, and a curved radiating metal member 22 above the dielectric substrate 20, the radiating metal member 22 being formed by punching and having two free ends, the radiating metal member 22 including two radial supports 231 and 232 in its intermediate portion, the supports 231 and 232 being bent and extended downward wherein the support 231 proximate an outer edge of the radiating metal member 22 has a bottom end electrically connected to circuitry in the dielectric substrate 20 for serving as a feed point and the support 232 proximate an inner edge of the radiating metal member 22 has a bottom end passed the dielectric substrate 20 to connect to the grounded metal element 21 for serving as a ground terminal.

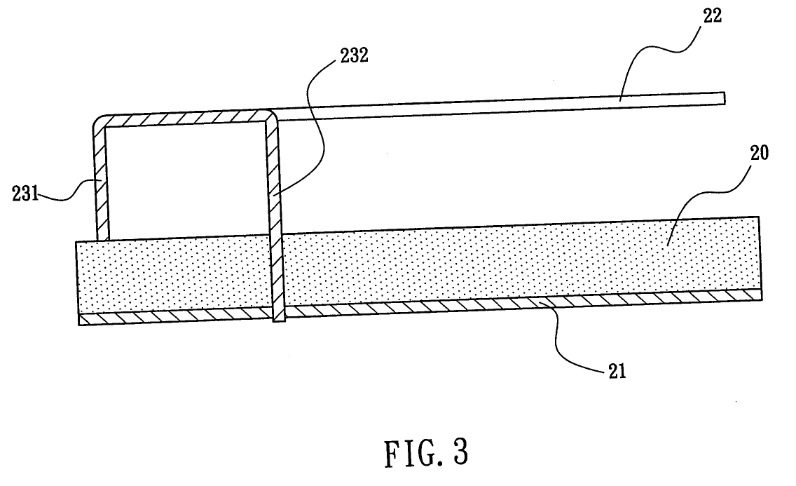

The planar antenna of the invention is thus constructed as the radiating metal member 22 formed above the dielectric substrate 20 and a predetermined distance maintained therebetween. Referring to FIG. 3, the supports 231 and 232 are formed integrally with the radiating metal member 22 and are bent, extended downward therefrom. As an end, added strength in construction is given to the radiating metal member 22 by the supports 231 and 232. Moreover, the predetermined distance between the radiating metal member 22 and the dielectric substrate 20 can be maintained. Further, the planar antenna is not subject to deformation due to collision or vibration and thus design characteristics of the planar antenna are ensured. In addition, the supports 231 and 232 and the radiating metal member 22 are formed by punching as contemplated by the invention in which a metal piece is punched to form the radiating metal member 22, the feed point of the support 231, and the ground terminal of the support 232 in one step. Thus, the manufacturing process is simple and time saving. Moreover, no soldering is required for joining the feed posts and the radiating metal member as experienced in the prior manufacturing process of planar antenna. And in turn it can decrease the manufacturing cost associated with the soldering of feed posts.

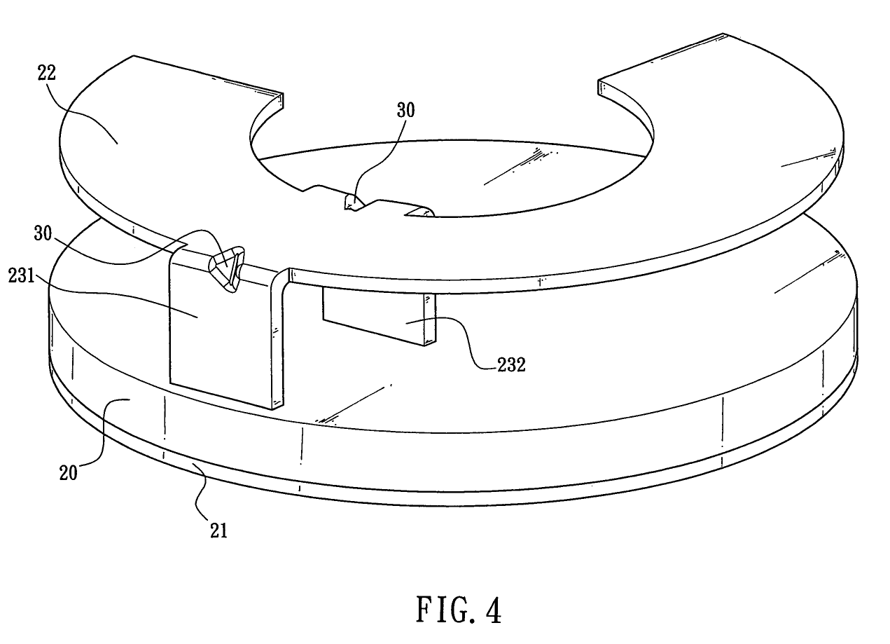

Referring to FIG. 4, a second preferred embodiment of planar antenna according to the invention is shown. The second preferred embodiment substantially has same structure as the first preferred embodiment. The characteristics of the second preferred embodiment are detailed below. After integrally forming the supports 231 and 232 with the radiating metal member 22 and bending and downward extending the supports 231 and 231, one or more (two are shown) ribs 30 each is formed by punching in the bent point of the support 231 (or 232) and the radiating metal member 22. The ribs 30 are adapted to give the bent points added strength in construction. Thus, the radiating metal member 22 is not subject to deformation due to collision or vibration and thus the predetermined distance between the radiating metal member 22 and the dielectric substrate 20 can be maintained, and design characteristics of the planar antenna are ensured.

Note that the dielectric substrate 20 is not limited to be formed of resin as discussed in the embodiments. Instead, it can be formed of other materials having the same dielectric property as resin. Further, the grounded metal element 21 is not limited to be formed under the dielectric substrate 20 by photolithography and etching. Instead, it can be formed by other techniques such as gluing depending on applications as contemplated by those skilled in the art without departing from the scope of the invention. Furthermore, the radiating metal member 22 is not limited to be curved as discussed in the embodiments. Instead, it can be any of other shapes as long as its shape and size are conformed to portions of the dielectric substrate 20 proximate its top edge and the planar antenna is adapted to operate in dual-band by configuring as a single feed double path antenna. All of these variations are within the scope of the radiating metal member 22 defined by the invention. Additionally, depending on applications those skilled in the art may downward extend the support 231 proximate an outer edge of the radiating metal member 22 to electrically connect to the grounded metal element 21 directly or pass the dielectric substrate 20 to connect to the grounded metal element 21 for serving as a ground terminal. In addition, still depending on applications those skilled in the art may downward extend the support 232 proximate an inner edge of the radiating metal member 22 to electrically connect to circuitry in the dielectric substrate 20 for serving as a feed point of the planar antenna. All of the above are within the scope of the invention.

In view of the above, the invention is embodied by forming the supports 231 and 232 integrally with the radiating metal member 22 and bending, extending downward same from the radiating metal member 22 such that the supports 231 and 232 are able to give added strength and rigidity in construction to the radiating metal member 22. As a result, both the dielectric substrate 20 and the radiating metal member 22 are not subject to deformation due to collision or vibration and thus the predetermined distance between the radiating metal member 22 and the dielectric substrate 20 can be maintained and design characteristics of the planar antenna are ensured. Moreover, impedance matching of the supports 231 and 232 can be adjusted by changing widths of both the supports 231 and 232 in order to design and manufacture an planar antenna complying with the specifications. In brief, the planar antenna of the invention not only completely solves the problem of weak construction of the prior planar antenna but also is able to obtain desired characteristics of the planar antenna mounted in a GSM or PDC based cellular phone.

While the invention herein disclosed has been described by means of specific embodiments, numerous modifications and variations could be made thereto by those skilled in the art without departing from the scope and spirit of the invention set forth in the claims.

What is claimed is:

1. A planar antenna with added strength in construction comprising:
a dielectric substrate;
a grounded metal element on bottom of the dielectric substrate; and
a radiating metal member above the dielectric substrate, the radiating metal member being formed by punching a metal piece and including two integral radial supports in its intermediate portion, the supports being bent and extended downward;
wherein one support has one end electrically connected to circuitry in the dielectric substrate for serving as a feed point, and the other support has one end passed the dielectric substrate to connect to the grounded metal element for serving as a ground terminal; and wherein the radiating metal member and the dielectric substrate are spaced apart by a predetermined distance by means of the supports.

2. The planar antenna of claim 1, wherein the radiating metal member is curved with two free ends and shape and size of the radiating metal member are conformed to portions of the dielectric substrate proximate a top edge.

3. The planar antenna of claim 1, wherein the radiating metal member is adapted to operate in dual-band by configuring as a single feed double path.

4. The planar antenna of claim 1, further comprising one or more ribs each formed in the bent point of either support and the radiating metal member.
